(19) United States
(12) Patent Application Publication
(10) Pub. No.: US 2014/0309012 A1
(43) Pub. Date: Oct. 16, 2014

(54) System, Device and Method for Providing One or More Bonus Games in a Keno, Bingo or Lottery Game

(71) Applicant: Bally Gaming, Inc., Las Vegas, NV (US)

(72) Inventor: Philip J. Anderson, Las Vegas, NV (US)

(73) Assignee: Bally Gaming, Inc., Las Vegas, NV (US)

(21) Appl. No.: 14/081,635

(22) Filed: Nov. 15, 2013

Related U.S. Application Data
(60) Provisional application No. 61/812,653, filed on Apr. 16, 2013.

(51) Int. Cl. G07F 17/34

(52) U.S. Cl. CPC G07F 17/34
USPC 463/20

(57) ABSTRACT

A system, device and method are set forth for providing a number based game such as Keno, Bingo or a Lottery. The player selects their numbers (or Bingo card) and prompts play. An outcome set of numbers is randomly chosen from a field of numbers and if the player has a predetermined outcome of matching numbers from their selected number they earn a prize. The game also randomly selects one or bonus numbers. If there is a match between one or more bonus numbers and the outcome set, one or more secondary spinning reel bonus games are enabled and are played resulting in winning or losing outcome. For winning outcomes the player earns a prize. Prizes may be progressive prizes.

### CROSS REFERENCE TO RELATED APPLICATION

This application is a non-provisional application of, and claims priority to, prior filed U.S. Provisional Patent Application 61/812,643 filed Apr. 16, 2013 and titled “A System, Device and Method for Providing One or More Bonus Games in a Keno, Bingo or Lottery Game”.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention relates to systems, devices and methods for providing secondary games into a base wagering game. More particularly it relates to systems, devices and methods for providing secondary games into number matching games such as Keno, Bingo or lottery games.

2. Description of the Related Art

Number matching games such as Keno, Bingo and lottery are well known. Casinos often have rooms or parlors designated to offer live Keno or Live Bingo. In Keno, a player selects a selection set of from one to twenty numbers on a game card having the numbers 1-80. In live Keno this is done by the player marking with a marker on a preprinted Keno card the player's selected set of numbers. As is known the player may select groupings in the selection set to define “ways”. For example the player may select six numbers and from those six numbers define one 6-number way and 14 2-number ways. Once the player has made their selections their card is handed to an attendant who logs the selections and produces a formal Keno ticket, usually a replication of the players Keno card, with the game number and marks matching the player's selection set. A Keno draw results 20 numbers being randomly drawn from the set of 1-80 to define an outcome set. If a player has a predetermined number of matches between his/her selection set and the outcome set they are entitled to an award. The odds for obtaining an award based upon the selection set are well defined.

Keno is played on electronic gaming machines as well. In an electronic version of Keno named “Caveman Keno” by IGT or Reno, Nevada, in addition to the player's selection set, three bonus numbers (different from the player's selections) are randomly selected and marked on the electronic display as dinosaur eggs along with the player's selection set. When the outcome set is drawn the outcome set numbers are marked on the display with any matches with the player's selection set highlighted. As with live Keno if the player has a predetermined number of matches between his/her selection set and the outcome set in the base Keno game they are entitled to an award. If there are a predetermined number of matches with the bonus numbers, e.g. 2 or more, the player is entitled to have any base Keno win multiplied.

The payback to a player for electronic Keno (basic) is typically around 85% meaning that, in the long run, for every dollar wagered the return to players will be 85% with 15% going to the house. The theoretical payback varies based upon the award schedule and the number of numbers in the player's selection set.

Lottery is a structured form of Keno requiring the player to play a fixed number of numbers in the selection set, e.g. 6 numbers from a field of 53 and only six numbers are drawn for the outcome set. As with Keno, if the player has a predetermined number of matches they are entitled to an award.

In live Bingo the players purchase Bingo cards which are represented by a 5×5 matrix. The columns are designated by the letters B-I-N-G-O and each has five numbers selected from within a specified range. Typically in live Bingo the players do not have the option to choose the numbers; but they can select cards to play. The purchase of the cards is used to fund the award and profit for the Bingo parlor. To win the player must be the first to obtain a winning Bingo pattern on their card. One example is a “coverall” game where the first player to have all their numbers matched by the outcome set wins the award. As is known other winning patterns may be designated.

In casinos it is well known to link gaming devices on a network system and to provide “system” based bonuses to players including progressive prizes. The progressive prize structure may be set to apply to one or more banks of the gaming terminals though a local controller or local area network (LAN) or across several casino properties through a wide area network (WAN). An example of a LAN based progressive prize structure may be Tracy, U.S. Pat. No. 5,116,055 issued May 26, 1992 and titled “Progressive Jackpot Gaming System Linking Gaming machines With Different Hit Frequencies and Denominations”, the disclosure of which is incorporated by reference. An example of a WAN based progressive award is MEGABUCKS® (IGT) which provides like configured slot machines games in numerous venues with a defined top prize, symbol-based, award. Portions of the wagers on these games are aggregated into an award pool (and to seed the new start up pool value) and when any qualifying player (i.e. the player has made the required wager amount to qualify for the prize) on the network obtains the top prize symbol combination, the top prize is awarded. These progressive prizes can be in several millions of dollars. The probability for winning the top prize is based upon the probability for obtaining the winning combination which is determined by the number of virtual reel stops for the reels of the game, the number of reels and the distribution of the top prize awarding symbols on the reels. Telnaes, U.S. Pat. No. 4,448,419 issued May 15, 1984 and titled “Electronic Gaming device Utilizing a Random Number Generator for Selecting the Reel Stop Positions” represents the shift from mechanical reels with reels stops to computer and video based games.

It has also been known to provide mystery bonus games which are not triggered from any base game outcome. These mystery awards can be provided on an individual machine basis but typically are provided over a bank of gaming terminals through a bank controller or on a system-wide basis through a system wide host server/controller arrangement. Examples of a bank delivered mystery bonuses are Torango, U.S. Pat. No. 6,592,460 issued Jul. 15, 2003 and titled “ Progressive Wagering System” and Olive, U.S. Pat. No. 7,056,215 issued Jun. 6, 2006 and titled “Slot Machine Game and System with Improved Jackpot Feature”, the disclosures of which are hereby incorporated by reference. These patents disclose allocation of a percentage of a players' wagers to a pool and with every play conducting a draw of one or more numbers from a set of numbers and if a predetermined match occurs awarding the player a mystery prize. The prize may be randomly selected and thereafter issued through the play of a secondary game. Since the prize is awarded apart from the base game and is not related to a base game winning or losing outcome, it is referred to as a mystery prize. The number set from which one or more random numbers are drawn is selected such that, theoretically, the jackpot award should hit after a certain amount of money has been wagered.

There have been disclosed slot machine games which have embedded secondary games. For example, in U.S. Pat. No. 7,727,069 issued Jun. 1, 2010 and titled “EMBEDDED REEL GAMES WITH PROGRESSIVES” and U.S. Pat. No. 8,113,952 issued Feb. 14, 2012 also entitled “EMBEDDED REEL GAMES WITH PROGRESSIVES”, the disclosures of which are incorporated by reference, there is disclosed a slot machine game having special symbols on the reels. When these special symbols appear in predetermined positions during the play of the main game, each animates into a miniature slot machine game having its own pay table and progressive. Games of this type have been sold by the assignee of the present invention, Bally Gaming, Inc. d/b/a Bally Technologies of Las Vegas, Nev., under the name HOT SHOT®.

There is a need to provide additional features for number matching based games such as Keno, Lottery and Bingo. There is a need to provide systems and methods for Keno and similar numbers matching games, which can be used to deliver system based features, games and bonuses. There is a need to provide number matching games which provide an opportunity to derive more revenue for a hosting venue such as a casino.

### SUMMARY OF THE INVENTION

There is provided according to one or more embodiments of the present invention a method, device and system are set forth for providing a secondary, spinning reel slot machine bonus game in association to a number selection game such as Keno, Lottery or Bingo. In one embodiment a method for playing a game on a video device having a video display is set forth which includes enabling a player to select one or more numbers to define a selecting set S, the number(s) selected from a field F of numbers. In a video game the selecting may be done, for example, at a touch screen display. Using Keno as an example, the selection set S may be from 1 to 10 numbers and the field F is numbers 1-80. A processor is configured for randomly selecting an outcome set O of numbers and a bonus number set B of at least one bonus number from the field F of numbers. In Keno the outcome set O would be 20 numbers selected from the field F of numbers 1-80. The bonus number set B can be one or more numbers, for example three randomly selected numbers. The method includes displaying at the video display (i) a comparison of said selection set S and said outcome set O and issuing a award to the player if the intersection of the sets (S∩O) has a predetermined characteristic. For example, in Keno, if the selection set S is four numbers the player must match at least two numbers from the outcome set for an award. In this example, therefore, S∩O≧ any 2 numbers. The method further includes comparing the bonus set B and said outcome set O and if B∩O has a predetermined relationship, for one or any instance of B∩O enabling play of a secondary, spinning reel bonus game to produce a spinning reel outcome. In an example, and not by way of limitation, B includes three numbers and all three must be found in the outcome set O to trigger the bonus game(s). That is, in the example, B∩O is any three numbers. For any enabled play of a secondary reel spinning bonus game a spinning reel game is played and if a winning outcome is obtained an award is issued to the player.

In an embodiment an award issued to the player for the spinning reel game may be a progressive award.

The spinning reel games may be of the type described in U.S. Pat. No. 7,727,069 issued Jun. 1, 2010 and titled “EMBEDDED REEL GAMES WITH PROGRESSIVES” and U.S. Pat. No. 8,113,952 issued Feb. 14, 2012 also entitled “EMBEDDED REEL GAMES WITH PROGRESSIVES”, the disclosures of which are incorporated by reference. In a non-limiting example, when the intersection of the sets B∩O produces a triggering outcome for each instance of the matching numbers a spinning reel bonus game is presented and played to produce a winning or losing outcome. For a winning outcome the player is issued an award over and above any award they received for the S∩O outcome. One or more outcomes may be a local, local area or wide area progressive jackpot. For example, at each bonus number match, a miniature slot machine display may be presented to play the embedded secondary spinning reel bonus game. Alternatively the secondary bonus game may be displayed at a margin or superimposed over the Keno, Bingo or Lottery display.

Also set forth is a gaming device for play by a player which includes a video display, a processor, apparatus for accepting a stake such as a wager input device and a player input device. The processor is configured to (i) accept input from the player input device to control the display to display a set S of numbers selected by the player from a field F of numbers. Where the game is a Keno game, a virtual Keno ticket matrix is displayed showing the field F numbers 1-80. The player input device is a touch screen input device configured for the player to touch one or more numbers for the selection set S. The processor is arranged to randomly select from said field F an outcome set O of a plurality of numbers (for Keno O is twenty randomly selected numbers) and a bonus set B of one or more numbers. The numbers of the outcome set O are also indicated on display. The processor compares the selected set S to the outcome set O and if S∩O has a predetermined characteristic issues an award to the player. For Keno, and depending upon the amount of numbers selected, e.g. 4 numbers, where the intersection between the selection set S and outcome set (S∩O) is two or more numbers the player may receive a prize. The processor also compares the bonus set B to the outcome set O and if B∩O has a predetermined relationship, e.g. one or more numbers of bonus set B match numbers of the outcome set O, play of a secondary, spinning reel bonus game is enabled to produce one or more spinning reel outcome bonus outcomes. An award for any winning secondary reel bonus outcome, e.g. 7-7-7. One or more bonus outcome awards may be progressive awards.

A system is also set forth which provides for communication between gaming devices and a controller to allocate stake wagers to one or more progressive pools which can be won where a secondary reel bonus game has a predetermined progressive winning outcome.

The devices, method and systems of the present invention may be played on stand along gaming devices, linked gaming devices or on remote devices such as cellular telephones, tablet computers, personal computers and laptops.

Other features and numerous advantages of the various embodiments will become apparent from the following detailed description when viewed in conjunction with the corresponding drawings.

### BRIEF DESCRIPTION OF THE DRAWINGS

FIG. 1 illustrates a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a casino enterprise communication network incorporating gaming terminals and which network may be used to configure progressive prizes according to one or more embodiments of the invention;

FIG. 5 is a diagram showing an example of an architecture for tying a casino enterprise network to an external provider of games and content to Internet or broadband communication capable devices;

FIG. 6 is a logic diagram showing an embodiment of the invention which includes a progressive prize; and

FIG. 7 illustrates a display showing the marking of a selection set by the player and a bonus set.

### DETAILED DESCRIPTION OF THE PREFERRED EMBODIMENTS

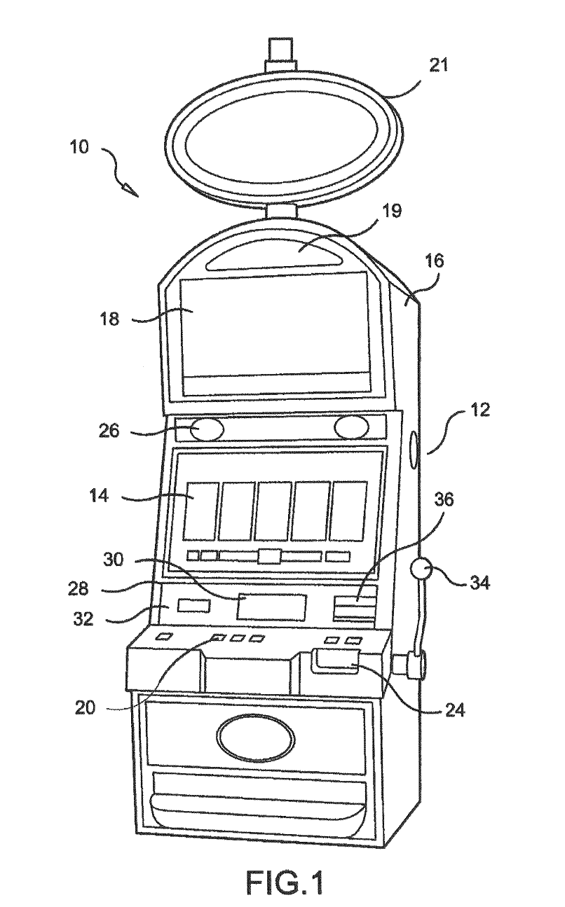

Referring now to the drawings, wherein like reference numbers denote like or corresponding elements throughout the drawings, and more particularly referring to FIG. 1, a gaming device 10 according to one or more embodiments of the present invention is shown. The gaming device 10 includes cabinet 12 providing an enclosure for the several components of the gaming device 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, and according to the various embodiments of present invention, the game content may be game outcomes based upon Keno, Bingo, video Lottery where number sets are used to define winning and losing outcomes. Unless otherwise specified an exemplary embodiment based on Keno shall be described. The foregoing description should not be deemed as limiting the content (graphics, video or text) which can be displayed at the primary game display 14. The cabinet 12 may comprise a slant-top, bar-top, or table-top style cabinet as is known in the art.

The gaming device 10 also includes in one or more embodiments a top box 16 which may support a printed back-lit glass (not shown) as is known in the art depicting the rules, award schedule, attract graphics or it may support a secondary game display 18 which may be of one of the types described above with reference to the primary game display 14. The top box 16 may also support a backlit glass with graphics defining a marquee 19 and a topper 21 including additional graphics.

To enable a player to provide input to the controller for the gaming device 10 a plurality of buttons 20 may be provided on a button deck for the gaming device 10. Additionally and alternatively one or both of the primary and secondary game displays 14, 18 may include touch screen input devices as are known in the art. Buttons, selections or inputs are displayed at the primary and secondary game displays 14, 18 and the player touching those icons or designated areas provides the required or desired input to configure and play the gaming device 10.

Other peripherals or associated equipment for the gaming device 10 include a bill/voucher acceptor 24 which reads and validates currency and vouchers for the player to establish credits for gaming on the gaming device 10 and one or more speakers 26 to provide audio to the player in association with the game play. To provide for communication between the gaming device 10 and a casino system, a player tracking module (PTM) 28 is mounted on the cabinet 12. PTM 28 has a PTM display 30 to display system related information to the player. The PTM display 30 may be a small LCD, plasma or OLED display with touch screen functionality. A card reader 32 is provided to read a machine readable component on a player loyalty card issued to the player to identify the player to the casino system as in known in the art. A ticket printer 36 may be provided as well on the PTM 28 or elsewhere on the gaming device 10 to provide printed value ticket vouchers to players as is known in the art.

Some functionality of the PTM 28 may be provided by a video switcher and touch router device as is described in U.S. Pub. App. 2009/0149253 entitled “Video Switcher and Touch Router Method for a Gaming Machine” filed Jan. 8, 2009 and incorporated by reference. According to this disclosure system and externally based content including the mystery game presentations as hereinafter described may be displayed at one or more of the primary or secondary displays 14, 18 dispensing with the need for the PTM display 30.

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming machine 10 so long as it provides access to a player for playing a game. For example, cabinet 12 may comprise a slant-top, bar-top, or table-top style cabinet, including a Bally Cinevision™ or CineReels™ cabinet. The gaming device 10 may include a controller and memory disposed within the cabinet 12 or may have thin client capability such as that some of the computing capability is maintained at a remote server.

The plurality of player-activated buttons 20 may be used for various functions such as, but not limited to, selecting a wager denomination, selecting a game to be played, selecting a wager amount per game, initiating a game, or cashing out money from gaming machine 10. Buttons 20 may be operable as input mechanisms and may include mechanical buttons, electromechanical buttons or touch screen buttons. In one or more embodiments, buttons 20 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary game display 14 and/or secondary display 18.

The primary game display 14 may present a base game of chance wherein a player receives one or more outcomes from a set of potential outcomes. For example, the gaming machine 10 may present a video Keno game, a Lottery game or a Bingo game.

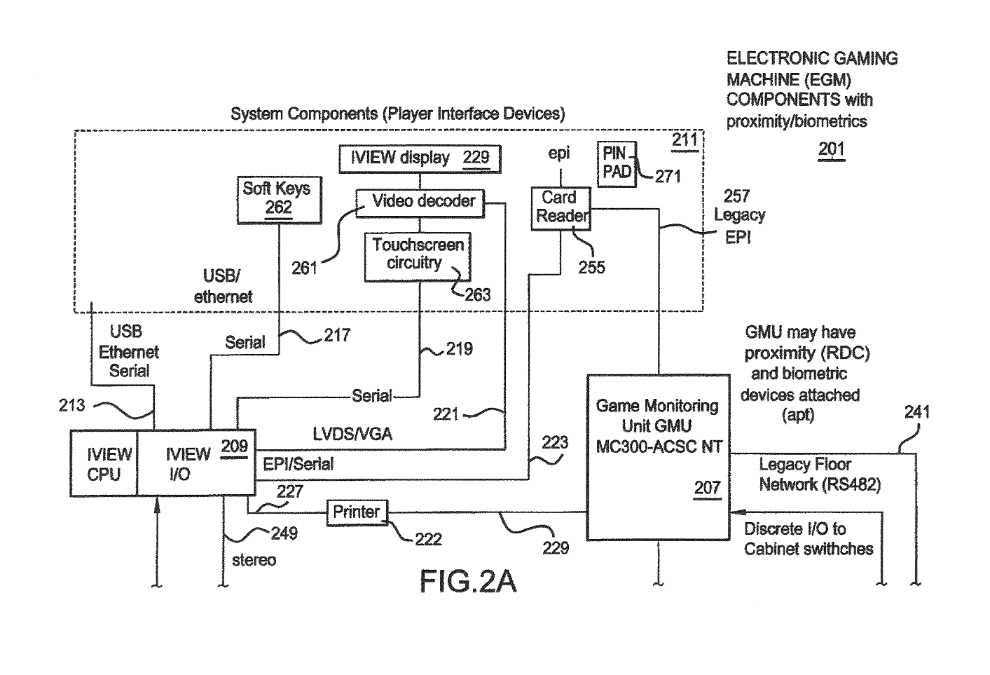

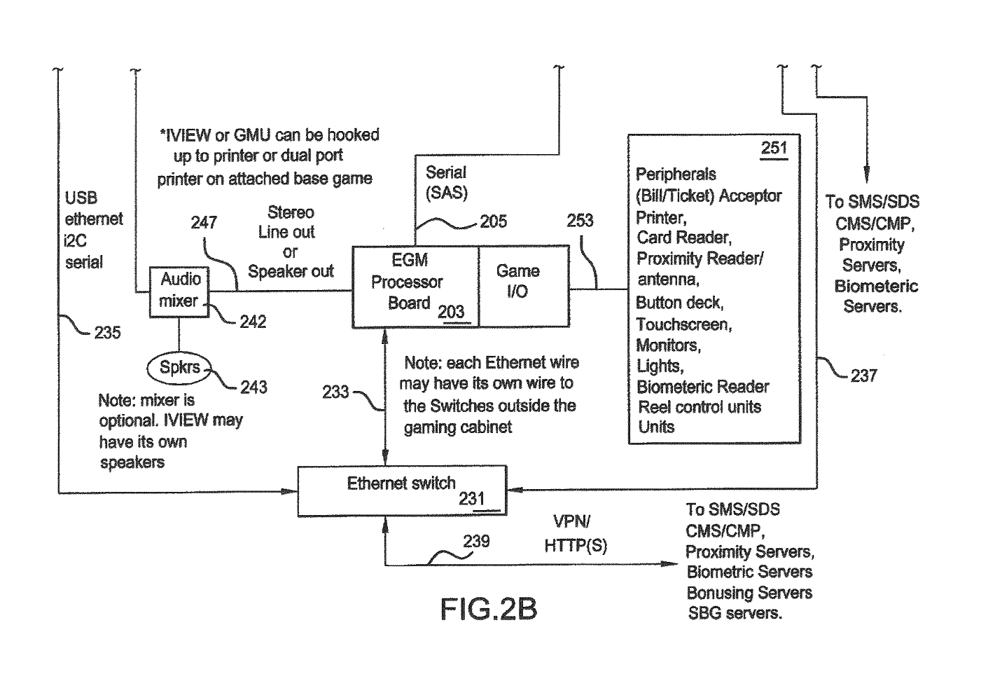

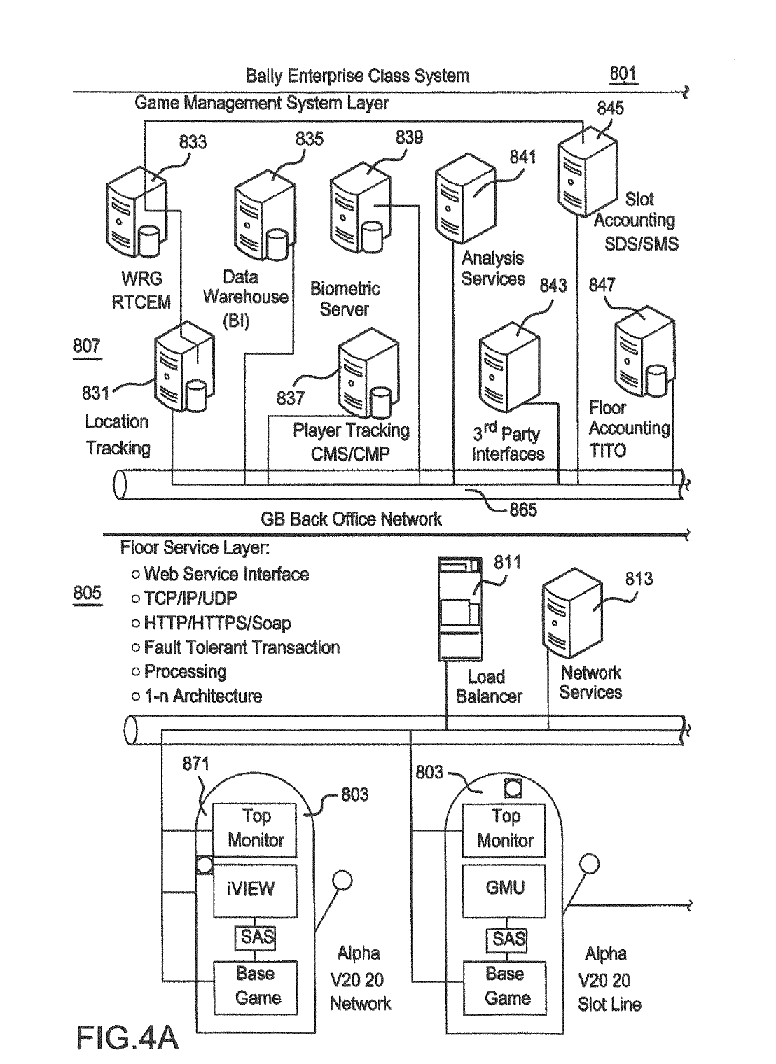

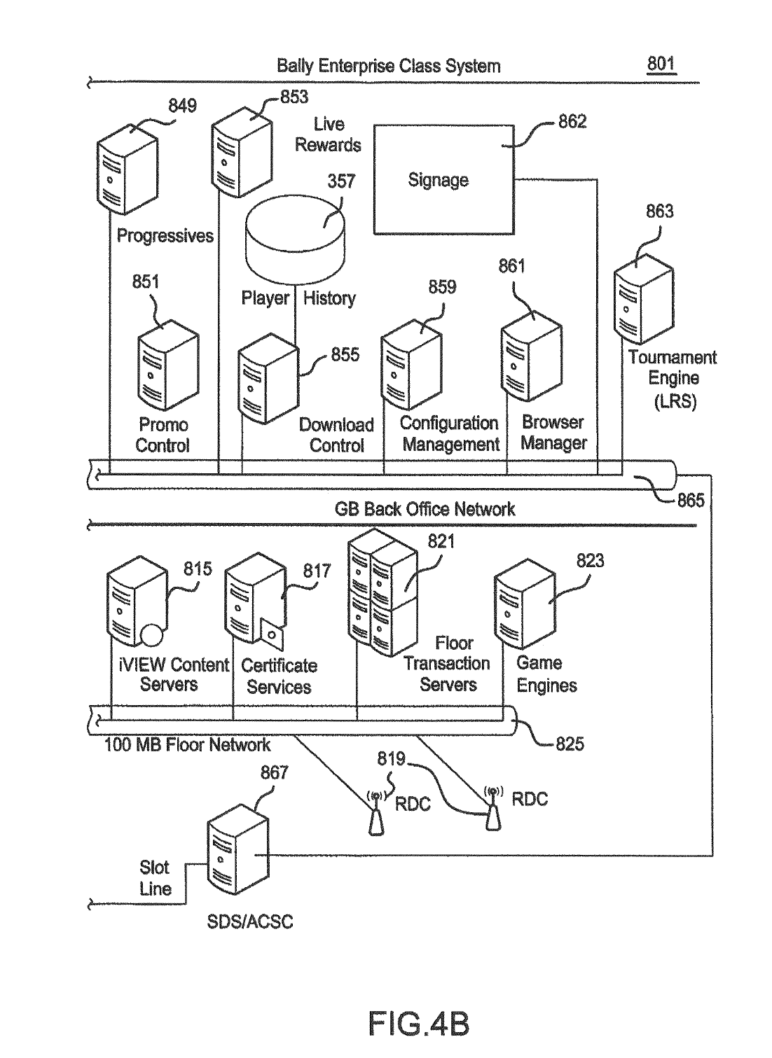

Referring to FIGS. 2A, B, the gaming device 10 hardware 201 for the controller(s) is shown in accordance with one or more embodiments. The hardware 201 includes base game processor board 203 (EGM Processor Board) connected through serial bus line 205 to game monitoring unit (GMU) 207 (such as a Bally MC300 or ACSC NT manufactured and sold by Bally Gaming, Inc., Las Vegas, Nev.). EGM Processor Board 203 is connected to the PID 209 over bus line 249 and PID 209 is connected to the iView device such as 211 in FIG. 2A through bus lines 213, 217, 219, 221, 223. The PID 209 provides for communication between one or more gaming devices 10 and the casino system such as the type as hereinafter described. Inasmuch as gaming devices 10 may be manufactured by different entities, mounting like PTMs 28, 211 and PIDs 209 at each gaming device 10 provides for communication to the system in one or more common message protocols. Typically when a casino enterprise purchases a casino management system they also purchase the same manufacturer's PTMs 28, 211 and PIDs 209 which are then installed by the various manufacturers of the gaming devices 10 for the enterprise before delivery. In this manner the mountings for the PTMs 28, 211 on the gaming devices can be configured for location and esthetic appearance. Gaming voucher ticket printer 36 (for printing player cash out tickets) (shown as 222 in FIG. 2A) is connected to PID 209 and GMU 207 over bus lines 227, 229. EGM Processor Board 203, PID 209 and GMU 207 connect to Ethernet switch 231 over bus lines 233, 235, 237. Ethernet switch 231 connects to a slot management system and a casino management system (SMS, SDS, CMS and CMP) (FIGS. 4A, 4B) network over bus line 239. Ethernet switch 231 may also connect to a server based gaming server or a downloadable gaming server. GMU 207 also may connect to the network over bus line 241. Speakers 26 (shown as 243 in FIG. 2B) to produce sounds related to the game or according to the present invention connect through audio mixer 242 and bus lines 247, 249 to EGM Processor Board 203 and PID 209.

Peripherals 251 connect through bus 253 to EGM Processor Board 203. The peripherals 251 include, but are not limited to the following and may include individual processing capability: bill/voucher acceptor 24 to validate and accept currency and ticket vouchers, the player interfaces such a buttons 20, primary and secondary game displays 14, 18 and any secondary or tertiary displays (with/without) touch screen functionality, monitors and lights. The peripherals 251 may include the displays as hereinafter described with reference to the various embodiments of the present invention as herein described or their equivalents. For example, the bill/voucher acceptor 24 is typically connected to the game input-output board of the EGM processing board 203 (which is, in turn, connected to a conventional central processing unit (“CPU”) board), such as an Intel Pentium® microprocessor mounted on a gaming motherboard. The I/O board may be connected to CPU processor board 203 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming device operating system (OS), such as a Bally Alpha OS. EGM processor board 203 executes a game program that causes the gaming device 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 253 to the I/O board and to EGM processor board 203 which, in turn, assigns an appropriate number of credits for play in accordance with the game program. The player may further control the operation of the gaming device by way of other peripherals 251, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary game display 14 as shown in FIG. 1. In some embodiments, the random generator may be physically separate from gaming device 10; for example, it may be part of a central determination host system which provides random game outcomes to the game program. Finally, EGM processor board 203 under control of the game program and OS compares the outcome to an award schedule. The set of possible game outcomes may include a subset of outcomes related to the triggering and play of a feature or bonus game. In the event the displayed outcome is a member of this subset, EGM processor board 203, under control of the game program and by way of I/O Board, may cause feature/bonus game play to be presented on the primary game display 14 and/or any secondary display(s) 18.

Predetermined payout amounts for certain outcomes, including feature game outcomes, are stored as part of the game program. Such payout amounts are, in response to instructions from EGM processor board 203, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming device may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 207 includes an integrated circuit board and GMU processor and memory including coding for network communications, such as the G2S (game-to-system) protocol from the Gaming Standards Association, Las Vegas, Nev., used for system communications over the network. As shown, GMU 207 may connect to the card reader 32 (shown as 255 in FIG. 2A) through bus 257 and may thereby obtain player information and transmit the information over the network through bus 241. Gaming activity information may be transferred by the EGM Processor Board 203 to GMU 207 where the information may be translated into a network protocol, such as S2S, for transmission to a server, such as a player tracking server, where information about a player's playing activity may be stored in a designated server database.

PID 209 includes an integrated circuit board, PID processor (iView CPU), and memory which includes an operating system, such as Windows CE, a player interface program which may be executable by the PID 209 processor together with various input/output (I/O) drivers for respective devices which connect to PID processor and which may further include various games or game components playable on PTM 28, 211 or playable on a connected network server and PTM 28, 211 is operable as the player interface. PID 209 connects to card reader 32 (shown as 255 in FIG. 2A) through bus 223, player tracking display 30 (shown as iView display 229 in FIG. 2A) through video decoder 261 and bus 221, such as an LVDS or VGA bus.

As part of its programming, the PID 209 processor executes coding to drive player tracking display 30, 229 and provide messages and information to a player. Touch screen circuitry 263 interactively connects PTM display 30, 229 and video decoder 261 to PTM 28, 211 such that a player may input information and causes the information to be transmitted either on the player's initiative or responsive to a query. Additionally soft keys 262 connect through bus 217 to PID 209 and operate together with the player tracking display 30 to provide information or queries to a player and receive responses or queries from the player. PID 209, in turn, communicates over the CMS/SMS network through Ethernet switch 231 and busses 235, 239 and with respective servers, such as a player tracking server.

PTMs 28 are linked into the virtual private network of the system components in gaming terminal 10. The system components include the player tacking module 28 (e.g. Bally iVIEW® device) (‘iView” is a registered trademark of Bally Gaming, Inc.), PID 209, EGM processing board 203 and game monitoring unit (GMU) processing board 207. These system components may connect over a network to the slot management system (such as a commercially available Bally SDS/SMS) and/or casino management system (such as a commercially available Bally CMP/CMS).

The GMU 207 system component has a connection to the base game through a serial SAS connection and is connected to various servers using, for example, HTTPs over Ethernet. Through this connection, firmware, media, operating system software, gaming device configurations can be downloaded to the system components from the servers. This data is authenticated prior to installation on the system components.

The system components include the PTM 28 processing board (PID 209) and game monitoring unit (GMU) 207. The GMU 207, PID 209 and PTM 28 can be combined into one like the commercially available Bally GTM iVIEW device. This device may have a video mixing technology to mix the EGM processor's video signals with the iVIEW display onto the top box monitor or any monitor on the gaming device.

The PTM 28 may also interface with a switcher and router device of the type described above. In such case, instead of providing the PTM display 30, the switcher and router device provides for the content normally display at the PTM display 30 to be displayed at one or more of the primary or secondary displays 14, 18.

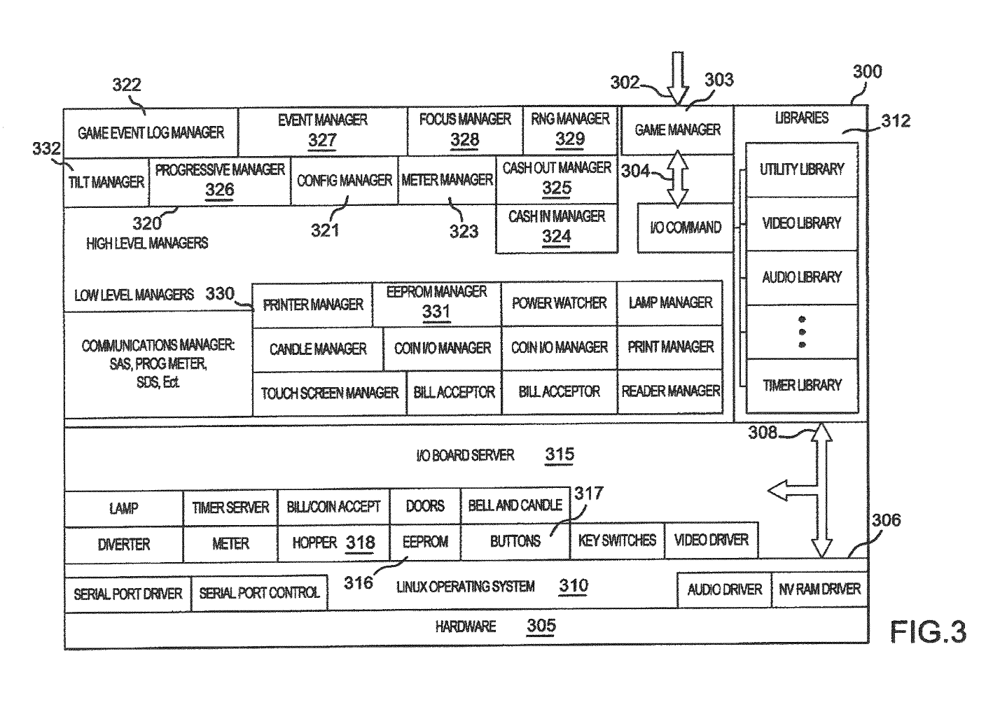

In accordance with one or more embodiments, FIG. 3 is a functional block diagram of a gaming kernel 300 of a game program under control of gaming device EGM processor board 203. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel layer having game manager 304 therein. In one or more embodiments, the use of an operating system layer 310, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 308, and itself contains a major component called the I/O board server 315. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 310 (see arrow 308). A few specific drivers remain in operating system layer 310's kernel, shown as those below line 306. These are built-in, primitive, or privileged drivers that are (i) general (ii) kept to a minimum and (iii) are easier to leave than extract. In such cases, the low-level communications is handled within operating system layer 310 and the contents passed to library routines 314.

Thus, in a few cases library routines may interact with drivers inside operating system layer 310, which is Y arrow 308 is shown as having three directions (between library routines 314 and I/O board server 315, or between library routines 314 and certain drivers in operating system layer 306). No matter which path is taken, the logic needed to work with each device is coded into modules in the user layer of the diagram. Operating board server layer 306 is kept as simple, stripped down, and common across as many hardware platforms as possible. The library utilities and user-level drivers change as dictated by the game cabinet or game device in which it will run. Thus, each game cabinet or game device may have an industry standard EGM processing board 203 connected to a unique, relatively dumb, and as inexpensive as possible I/O adapter board, plus a gaming kernel 300 which will have the game-device-unique library routines and I/O board server 315 components needed to enable game applications to interact with the gaming device cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 330, although lower level managers 330 may be accessible through game manager 304's interface if a programmer has the need. In addition to the freedom derived from not having to deal with the hardware level drivers and the freedom of having consistent, callable, object-oriented interfaces to software managers of those components (drivers), game manager 304 provides access to a set of high level managers 320 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game device, including other objects, after game manager 304 has started its internal objects and servers in appropriate order. In order to carry out this function, the kernel's configuration manager 321 is among the first objects to be started; configuration manager 321 has data needed to initialize and correctly configure other objects or servers.

The high level managers 320 of game kernel 300 may include game event log manager 322 which provides, at the least, a logging or logger base class, enabling other logging objects to be derived from this base object. The logger object is a generic logger; that is, it is not aware of the contents of logged messages and events. The game event log manager's 322 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 323 manages the various meters embodied in the game kernel 300. This includes the accounting information for the game device and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 323 receives its initialization data for the meters, during start-up, from configuration manager 321. While running, the cash in manager 324 and cash out manager 325 call the meter manager's 323 update functions to update the meters. Meter manager 323 will, on occasion, create backup copies of the soft meters by storing the soft meters' readings in EEPROM. This is accomplished by calling and using EEPROM manager 331.

In accordance with still other embodiments, progressive manager 336 manages progressive games playable from the game device. Event manager 327 is generic, like game event log manager 327, and is used to manage various gaming device events. Focus manager 328 correlates which process has control of various focus items. Tilt manager 332 is an object that receives a list of errors (if any) from configuration manager 321 at initialization, and during game play from processes, managers, drivers, etc. that may generate errors. Random number generator manager 329 is provided to allow easy programming access to a random number generator (RNG), as a RNG is required in virtually all casino-style (gambling) games. Random number generator manager 329 includes the capability of using multiple seeds.

In accordance with one or more embodiments, a credit manager object (not shown) manages the current state of credits (cash value or cash equivalent) in the game device, including any available winnings, and further provides denomination conversion services. Cash out manager 325 has the responsibility of configuring and managing monetary output devices. During initialization, cash out manager 325, using data from configuration manager 321, sets the cash out devices correctly and selects any selectable cash out denominations. During play, a game application may post a cash out event through the event manager 327 (the same way all events are handled), and using a call back posted by cash out manager 325, cash out manager 325 is informed of the event. Cash out manager 325 updates the credit object, updates its state in non-volatile memory, and sends an appropriate control message to the device manager that corresponds to the dispensing device. As the device dispenses dispensable media, there will typically be event messages being sent back and forth between the device and cash out manager 325 until the dispensing finishes, after which cash out manager 325, having updated the credit manager and any other game state (such as some associated with meter manager 323) that needs to be updated for this set of actions, sends a cash out completion event to event manager 327 and to the game application thereby. Cash in manager 324 functions similarly to cash out manager 325, only controlling, interfacing with, and taking care of actions associated with cashing in events, cash in devices, and associated meters and crediting.

In a further example, in accordance with one or more embodiments, I/O board server 315 may write data to the gaming device EEPROM memory, which is located in the gaming device cabinet and holds meter storage that must be kept even in the event of power failure. Game manager 304 calls the I/O library functions to write data to the EEPROM. The I/O board server 315 receives the request and starts a low priority EEPROM manager 331 thread within I/O board server 315 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 317 within I/O board server 315, polls (or is sent) the state of buttons every 2 ms. These inputs are debounced by keeping a history of input samples. Certain sequences of samples are required to detect a button was pressed, in which case the I/O board server 315 sends an inter-process communication event to game manager 304 that a button was pressed or released. In some embodiments, the gaming device may have intelligent distributed I/O which debounces the buttons, in which case button module 317 may be able to communicate with the remote intelligent button processor to get the button events and simply relay them to game manager 304 via IPC messages. In still another embodiment, the I/O library may be used for pay out requests from the game application. For example, hopper module 318 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming enterprise system 801 is shown in accordance with one or more embodiments. Gaming enterprise system 801 may include one casino or multiple locations (herein referred to collectively as a casino enterprise) and generally includes a network of gaming terminals 803 (including gaming devices 10 of the type as described in FIG. 1), floor management system (SMS) 805, and casino management system (CMS) 807. SMS 805 may include load balancer 811, network services server 813, player tracking module 28, iView (PTM 28), content servers 815, certificate services server 817, floor radio dispatch receiver/transmitters (RDC) 819, floor transaction servers 821 and game engines 823 (where the gaming terminals 803 operate server based, server supported or downloadable games), each of which may connect over network bus 825 to gaming terminals 803. CMS 807 may include location tracking server 831, WRG RTCEM (William Ryan Group Real Time Customer Experience Management from William Ryan Group, Inc. of Sea Girt, N.J.) server 833 , data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485,Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming device. The GMU (shown as GMU 206 in FIG. 2A) has a connection to the base game through a serial SAS connection. The system components in the gaming cabinet may be connected to the servers using HTTPs or G2S protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming devices 803 may be number selection games such as a video Bingo machine, Keno machine, Lottery machine or a gaming device offering one or more of the above described games. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in Vallejo et al U.S. Published Application 2008/0139305, entitled “Networked System and Method for Group Gaming,” filed on Nov. 9, 2007, the disclosure of which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, player rating level, available player comp points (points accumulated based upon commercial “spend” activity with the enterprise including gaming and which may be redeemed or converted into cash or merchandise) and the like. As is known in the industry and according to the prior art, at enrolment the player is assigned a created account in the player tracking CMS/CMP server 837 and is issued a player tracking card having a machine readable magnetic stripe.

When a player plays a gaming device 10 (or terminal 803) (hereinafter collectively referred to as gaming devices 10), he/she inserts their player tracking card into the card reader 32 (FIG. 1) which communicates data to the CMS/CMP server 837 to accumulate loyalty (“comp”) points based upon the wagers/wins of the player. For example, a player may accumulate one comp point for each $5 wagered. Comp points may also be awarded as part of a promotion and for other commercial activity such as the purchase of goods or services.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

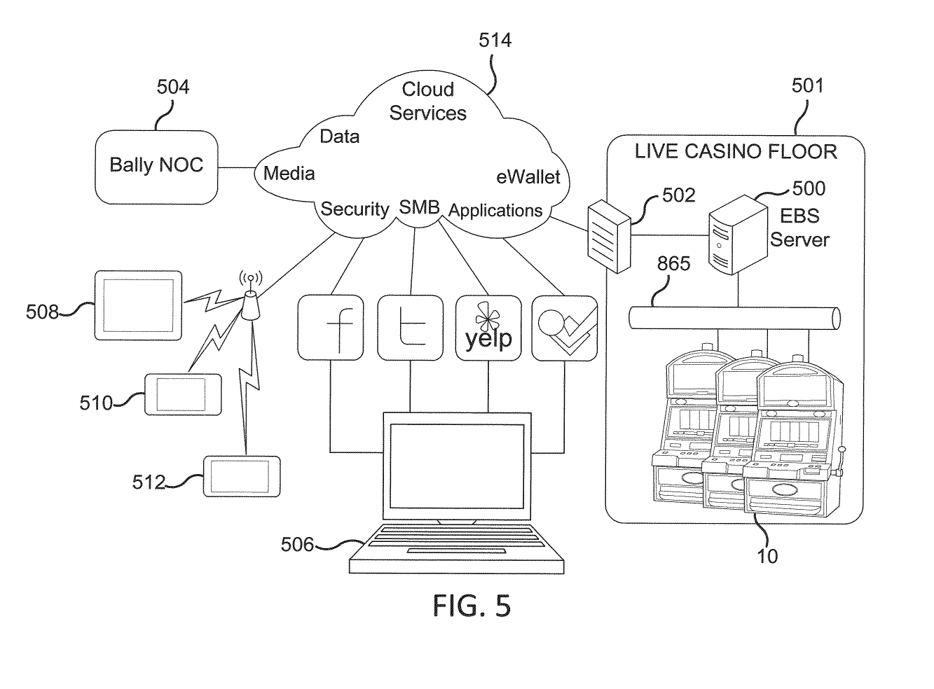

All or portions of the present invention may be implemented or promoted by or through a system as suggested in FIG. 5. At 501 is the gaming enterprise system which may be hosted at a casino property enterprise, across several casino enterprises or by a third party host. As described above the gaming enterprise system 501 has a network communication bus 865 providing for communication between the gaming devices 10 and various servers as described above with respect to FIGS. 4A,B. To provide the functionality illustrated in FIG. 5, a feature server 500, such as a Bally Elite Bonusing Server, is connected to the network communication bus 865 for communication to the gaming system 801, the gaming devices 10 and the various servers and other devices as described above. Through a secure network firewall 502 the feature server 500 is in communication with a cloud computing/storage service 514 which may be hosted by the casino enterprise, a licensed third party or if permitted by gaming regulators an unlicensed provider. For example the cloud service 514 may be as provided by Microsoft® Private Cloud Solutions offered by Microsoft Corp. of Redmond, Wash., USA. The cloud service 514 provides various applications which can be accessed and delivered to, for example, personal computers 506, portable computing devices such as computer tablets 508, personal digital assistants (PDAs) 510 and cellular devices such as telephones and smart phones 512. For example the cloud service 514 may provide and support the enterprise applications in association with the feature server 500. The cloud service 513 may also facilitate the delivery of content to user/players by supporting updates and advertising through the enterprise applications to the remote device user/player. The cloud service 514 includes security provide for secure communication with the cloud service 514 between the player/users and the cloud service 514 and between the cloud service 514 and the gaming enterprise system 501. Security applications may be through encryption, the use of personal identification numbers (PINS), biometric identification, location determination or other devices and systems. As suggested in FIG. 5 the cloud service 515 stores or accesses player/user data retrieved from players/users and from the gaming enterprise system 501 and feature server 500.

The players/users may access the cloud service 514 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace or LinkedIn or the like.

As but an example, a player/user may have a player account with a casino enterprise. That account may include data such as the player's credit level, their rating and their available comps. At their smart phone 512 the player/user sends a request to the cloud service 514 (perhaps through a previously downloaded application) to request a the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN or some other unique identifier such as a biometric identifier or tag. The cloud service 514 forwards the inquiry to the feature server 500 which, in turn, confirms the identification and retrieves the requested information from the data warehouse 835 or player history database 857 or player tracking CMS/CMP server 837. The information is formatted by the cloud service 514 application and delivered to the player/user. The delivery may be formatted based upon the player/user's device operating system (OS), display size or the like.

The cloud service 514 may also host game applications to provide virtual instances of games for free, promotional, or where permitted, P2P (Pay to Play) supported gaming. Third party developers may also have access to placing applications with the cloud service 514 through, for example a national operations center (Bally NOC 504). A game software manufacturer such as Bally Gaming, Inc. may also provide game applications on its own or on behalf of the casino enterprise.

Other media such as advertising, notices (such as an upcoming tournament) promotions and surveys may also be provided to and through the cloud service 514. When a player/user accesses the cloud service 514 certain media may be delivered to the player/user in a manner formatted for their application and device.

The cloud service 514 enables the casino enterprise to market to and foster player loyalty. To drive such interaction various incentive programs may be employed including, as described above, users earning or being awarded mystery game chances which may be redeemed at their next visit to the casino enterprise or, where permitted, during play on their remote devices.

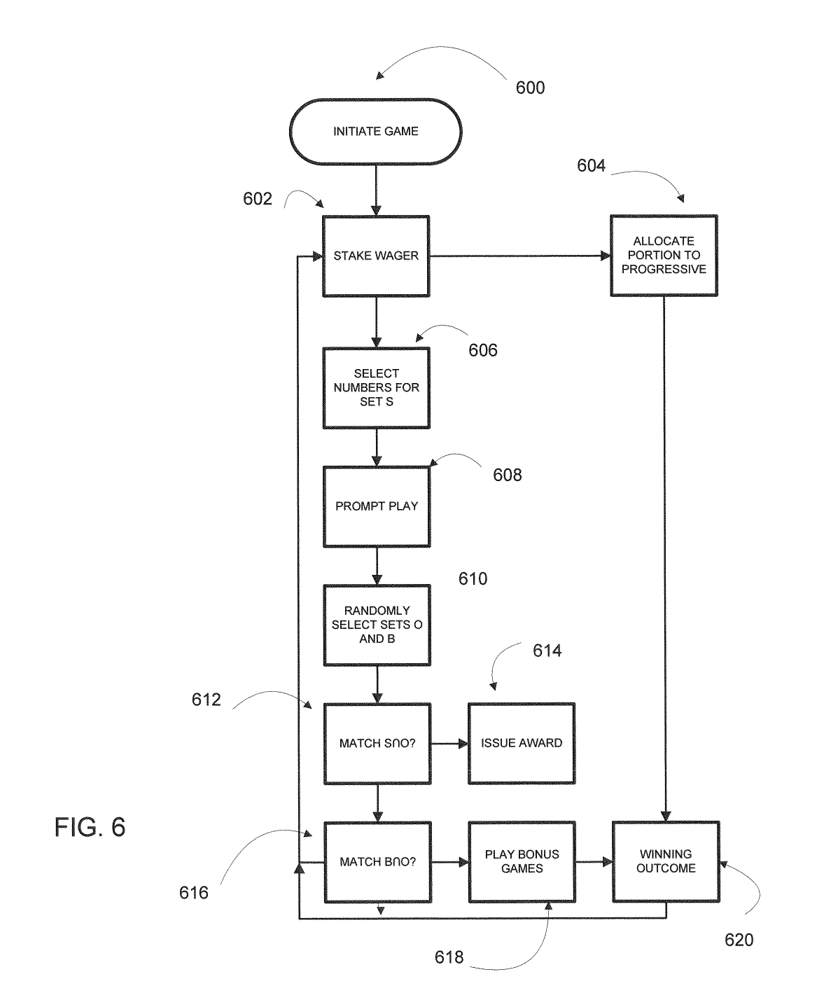

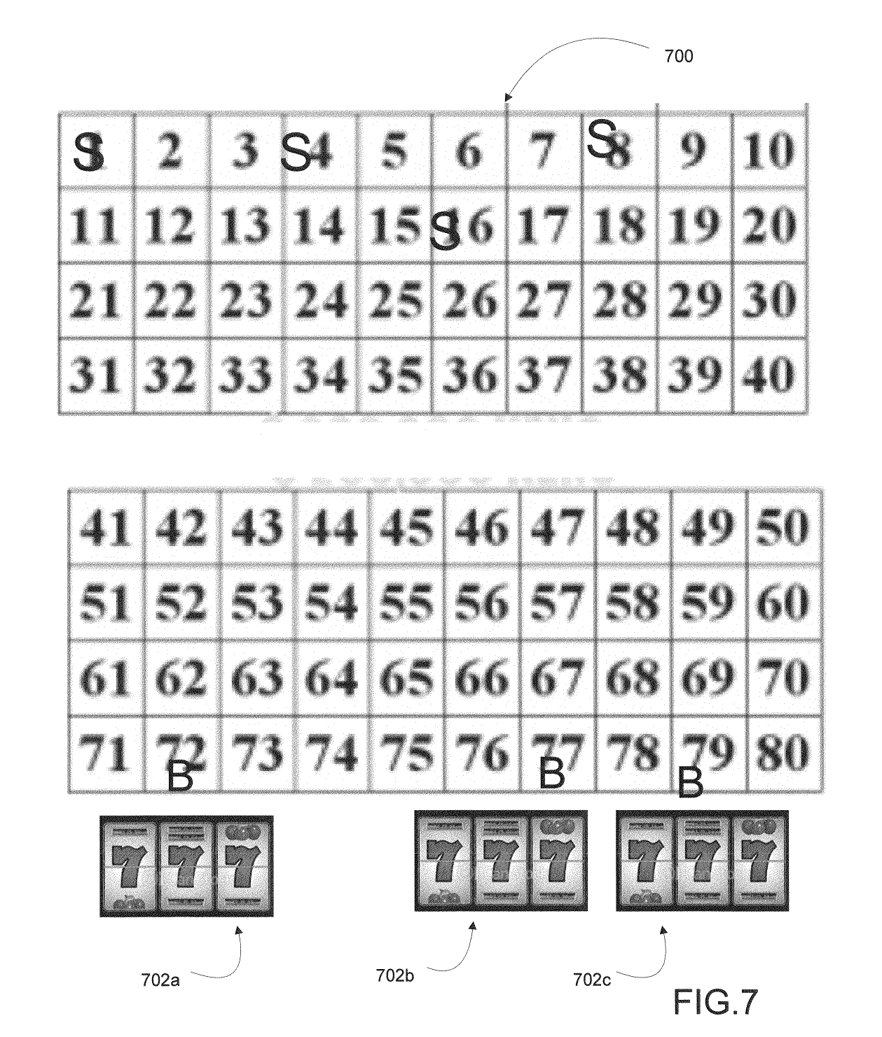

Turning to FIGS. 6 and 7 various embodiments of the present invention will be described where the game is a video Keno game. At 600 the game at a gaming device 10 (or 803 as referenced in FIG. 4A) is initiated by, for example, the player selecting to play the game or awaking the gaming device 10 from a sleep, standby or advertising mode. Insertion of a player's loyalty card may suffice to initiate the game. As shown in FIG. 7 where the game is Keno the display would display a virtual Keno card 700 to the player. At 602 the player registers a stake, i.e. makes a wager, to play the game. The wager may come from established credits (monetary or virtual depending upon whether the game is a P2P game) at the gaming device 10, inserting coins/tokens, or downloading funds from an electronic account. If the gaming device 10 is incorporated into a progressive grouping as described above at 604 a portion of the wager is allocated to one or more progressive jackpots.

The player, at 606 selects a group of numbers from an offered field of numbers. As described herein the selected numbers defines a selection set S whereas the field of numbers from which the selection is made is the field set F. For Keno, as shown in FIG. 7, the field set F is the numbers 1-80. Using a player input device such as buttons or a touch screen the player touches the desired numbers for the selection set S on the displayed Keno card 700. For a lottery game the field set may be the numbers 1-52 or the numbers 1-56 as well as a second field set F₂ of 1-46 such as in the California Lottery Mega Millions® game. For a Bingo game the field set is the numbers 1-75 with a subset of the numbers arranged in a 5×5 matrix having column designators B-I-N-G-O. For an embodiment of the invention where Bingo is the game, the player would select a Bingo card having numbers from the field randomly distributed with the B column having five numbers from 1-15, I from 16-30, N from 31-45, G from 46-60 and O from 61-75 as is known in the art. In such as case the numbers of the selected Bingo card represent the selection set S. The player may be given the option of selecting numbers for their Bingo card (according to the defined column number restrictions described above) or may scan through offered cards to select one they prefer or the card may be randomly populated. With reference to FIG. 7 and the Keno game, the player has selected the numbers denoted by S of 1, 4, 8 and 16 as their selection set S. After the player has selected their selection set S at 608 play of the game is prompted.

When the game is prompted the game processor, e.g. EGM processor board 203 (FIG. 2B) at 610 randomly selects an outcome set O of numbers from the field set F as well as a bonus set B of numbers. For Keno the outcome set O would be twenty numbers randomly selected from the field set F. For Bingo a predetermined number of outcome set numbers from the field set of 1-75 may be selected or the selection may continue until a predetermined pattern is formed on a Bingo card. For a lottery typically the outcome set O includes six numbers randomly selected from the field set F (and F₂ where provided).

The selected outcome set O is marked in the display such as on a displayed Keno card 700. This may be done en masse or preferable in a sequence to build suspense for the player. At 612 the processor, e.g. EGM processor board 203 (FIG. 2B), compares the intersection of the selection set S with the outcome set O (S∩O) to look for matching numbers from the sets. In Keno the number of matches required for a winning outcome depends upon the numbers selected. For example, in video Keno the player may select from 1 number to 10 numbers (live Keno permits more numbers in the selection set). If the player selects 1 number then they have to match that number for a winning outcome. If instead they select four numbers for the selection set as shown in FIG. 7, then they may get a small award for matching two numbers with the outcome set, a greater award for matching three numbers and the highest award for matching all four numbers. This aspect of video Keno is well known in the art. If there are sufficient matches between the numbers of the selection set S and the outcome set O to result in an award at 614, a Keno award is issued to the player. The processor then compares the numbers of the bonus set B and the outcome set O (B∩O) at 616 and if the intersection results in a predetermined number of matches one or more secondary spinning reel bonus games are enabled at 618. As an example, the bonus set B may be three randomly selected numbers from the field set F as suggested in FIG. 7 as the numbers indicated by B which are the numbers of 72, 77 and 79. If indeed B∩O results in the numbers 72, 77 and 79 then one or more secondary spinning reel bonus games are enabled and played at 618. More or fewer numbers may be in the bonus set B and the secondary spinning reel bonus games may be enabled by matching all, one or at least some of the bonus numbers. If there are no or an insufficient number of matches from B∩O the game is over and the player is returned to 602 to make another wager to play a next game.

FIG. 7 illustrates examples of the presentation of the secondary spinning reel bonus games 702a-c. The games may be single line or multi-line spinning reel slot machine game presentations. The games may be similar for each B∩O matching instance on the Keno card 700 or the games may be different with different pay tables, symbols and/or pay lines. While not shown in FIG. 7 each spinning reel bonus game 702a-c has an associated pay table showing winning outcomes and the awards therefore. One or more of the secondary spinning reel games 702a-c may have an associated progressive prize for one or more outcomes. When enabled, the secondary spinning reel bonus games animate spinning and stopping to define a randomly selected outcome at one or more defined pay lines. For each winning outcome from any secondary spinning reel game 702a-c the player at 620 is issued an award. If no secondary spinning reel game results in a winning outcome, the game is over and the player is returned to 602 to make another wager to play a next game.

The secondary spinning reel bonus game(s) may be presented overlying the matching numbers from the bonus set B, or off to one side of the Keno card 700. The secondary spinning reel bonus game(s) may be presented to be played simultaneously or sequentially.

The foregoing game may be played in a casino environment or online where P2P play is permitted and may be played for entertainment only purposes. Where play is remote such as on a cellular telephone the user may download a suitable application from the cloud 514 or may play the game as a server based game.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

I claim:

1. A method for playing a game on a video device having a video display comprising:
enabling a player to select numbers to define a selection set S from a field set F of numbers;
randomly selecting an outcome set O of numbers and a bonus number set B of at least one bonus number from the field set F of numbers;
displaying at said video display (i) a comparison of said selection set S and said outcome set O and issuing a award to the player if S∩O has a predetermined characteristic and (ii) a comparison of said bonus set B and said outcome set O and if B∩O has a predetermined relationship, for one or any instance of B∩O enabling play of a secondary, spinning reel bonus game; and
displaying the play for any enabled play of a secondary reel spinning bonus game and issuing an award for any secondary reel spinning bonus game having a predetermined outcome.

2. The method of claim 1 comprising enabling a player to select one or more numbers to define a selection set S for a Keno game, said number selected from a field set F of the numbers 1-80.

3. The method of claim 1 comprising displaying for a predetermined number N of instances of B∩O enabling play of a secondary, spinning reel bonus game to produce a spinning reel outcome.

4. The method of claim 1 comprising randomly selecting a bonus number set B of at least 2 numbers.

5. A method for playing a Keno game on a video device comprising:
enabling a player to place a wager and select one or more numbers to define a selection set S, said number selected from a field set F of numbers 1-80;
randomly selecting an outcome set O of 20 numbers and a bonus number set B of at least one bonus number from the field set F of numbers 1-80;
displaying at said video display (i) a comparison of said selection set S and said outcome set O and issuing a award to the player if S∩O has a predetermined characteristic issuing an award to the player and (ii) a comparison of said bonus set B and said outcome set O and if B∩O has a predetermined relationship, for one or any instance of B∩O enabling play of a secondary, spinning reel bonus game; and
displaying the play for any enabled play of a secondary reel spinning bonus game and issuing an award for any secondary reel spinning bonus game having a predetermined outcome.

6. A method for playing a Bingo game on a video device comprising:
enabling a player to place a wager and select a Bingo card defining a selection set S of numbers, said numbers selected from a field set F of Bingo numbers;
randomly selecting an outcome set O of numbers and a bonus number set B of at least one bonus number from the field set F of numbers;
displaying at said video display (i) a comparison of each Bingo card selection set S and said outcome set O and issuing a award to the player if S∩O has a predetermined characteristic and (ii) comparing said bonus set B and said outcome set O and if B∩O has a predetermined relationship, for one or any instance of B∩O enabling play of a secondary, spinning reel bonus game; and
displaying the play for any enabled play of a secondary reel spinning bonus game and issuing an award for any secondary reel spinning bonus game having a predetermined outcome.

7. A gaming device for play by a player comprising:
a video display;
a processor;
apparatus for accepting a wager;
a player input device;
said processor configured to (i) accept input from said input device and control the display to display a selection set S of numbers selected by the player from a field set F of numbers, (ii) randomly select from said field F an outcome set O of a plurality of numbers and a bonus set B of one or more numbers, (iii) compare the selection set S to the outcome set O and if S∩O has a predetermined characteristic issuing an award to the player, (iv) compare the bonus set B to the outcome set O and if B∩O has a predetermined relationship, for one or any instance of B∩O enabling play of a secondary, spinning reel bonus game, and (v) displaying the play for any enabled play of a secondary reel spinning bonus game and issuing an award for any secondary reel spinning bonus game having a predetermined outcome.

8. The device of claim 7 comprising at least one spinning reel bonus game outcome includes a progressive prize.

9. A system for playing games on a plurality of devices on a communication network each including a video display comprising:
a processor associated with each device;
apparatus for accepting a stake for the play of a game at each device;
a progressive controller in communication with said network and configured to allocate a portion of each stake to at least one progressive prize pool and to detect a progressive winning bonus outcome at any device;
a player input device at each device;
said processor configured to (i) accept input from said input device and control the display to display a selection set S of numbers selected by the player from a field set F of numbers, (ii) randomly select from said field F an outcome set O of a plurality of numbers and a bonus set B of one or more numbers, (iii) compare the selection set S to the outcome set O and if S∩O has a predetermined characteristic issuing an award to the player, (iv) compare the bonus set B to the outcome set O and if B∩O has a predetermined relationship, for one or any instance of B∩O enabling play of a secondary, spinning reel bonus game, (v) displaying the play for any enabled play of a secondary reel bonus game and issuing an award for any secondary reel bonus having a predetermined outcome and (vi) issuing a progressive prize for a secondary reel bonus game having a predetermined progressive winning bonus outcome.
